(19) United States
(12) Patent Application Publication
(10) Pub. No.: US 2009/0037264 A1
(43) Pub. Date: Feb. 5, 2009

(54) METHOD AND SYSTEM FOR PROVIDING COUPONS TO SELECT CONSUMERS

(76) Inventors: James Robert Del Favero, Mountain View, CA (US); Lisa Cohen Gevelber, Palo Alto, CA (US); Roy Matthew Rosin, Wayne, PA (US); George A. Hansen, Danville, CA (US); Michael Fitzgibbon, Sebastopol, CA (US); Paul Jeffrey Rosenfeld, Mountain View, CA (US); John W. Zackrison, Santa Clara, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/831,239

(22) Filed: Jul. 31, 2007

(51) Int. Cl. G06Q 30/00; G06F 17/30; G06Q 40/00

(52) U.S. Cl. 705/14

(57) ABSTRACT

A method and system for providing coupons to select consumers includes a process for providing coupons to select consumers whereby a coupon provider defines one or more coupon eligibility criterion that must be met by a consumer in order for the consumer to be eligible to receive one or more coupons. Access to data representing the one or more coupon eligibility criterion is then provided. A consumer's financial data is then obtained from one or more sources using a computing system implemented financial management system. In one embodiment, using the consumer's financial data and the data representing the one or more coupon eligibility criterion, one or more coupons are identified that the consumer is eligible to receive. In one embodiment, the consumer is then provided access to the one or more coupons identified that the consumer is eligible to receive.

### BACKGROUND

Many providers of consumer goods and services, and other advertisers, offer coupons, and/or other marketing devices such as discount certificates, price guarantees, and vouchers, to consumers in an effort to attract and/or encourage business.

Traditionally, coupons have been distributed in “hard-copy”, typically printed, form by various means, including, but not limited to: by mail; in newspapers; in magazines; in flyers and inserts; at store front and/or product displays; and/or as attachments to store receipts (i.e., printed on the back of a receipt or appended to a receipt). More recently, coupons have been offered/distributed using electronic means such as, but not limited to: networks of computing systems, including public networks such as the Internet; through and/or on web-sites; by e-mail; as electronic coupon attachments to electronic receipts; and as electronic coupon attachments to transactional data, such as, but not limited to transactional data from and/or displayed by, banks, credit card companies, and other financial institutions.

Many coupons offer significant discounts to the consumer holding, and meeting the terms of, the coupon. Therefore, coupons can represent a significant expense to the coupon provider. Typically, the coupon provider is willing to this expense to meet specific coupon provider goals, including, but not limited to: to help build up a customer base; to get consumers into a store; to retain customers who find a lower price for an item from a competitor; to lure customers away from a competitor; and/or to help clear excess inventory and/or to boost sales of a given product. Similarly, credit card companies and/or banks are often willing to offer coupons to encourage use of their accounts, credit cards, and/or lines of credit and/or in a partnership with selected retailers and/or manufacturers.

In order to most efficiently use their marketing and/or advertising resources, coupon providers would often like to send coupons, or special coupons, to select consumers who are particularly desirable to the coupon provider. For instance, a coupon provider may be particularly interested in targeting select consumers with coupons, or special coupons, who shop with a competitor, or spend a threshold amount of money each month on products and/or services the coupon provider offers. A coupon provider may also be particularly interested in targeting select consumers of specific economic and social demographics, or who reside and/or shop in a specific geographic location. In other instances, a coupon provider may be particularly interested in targeting select consumers with coupons, or special coupons, who meet any other criteria of interest.

Despite the desire of coupon providers to target select consumers who are particularly desirable to the coupon provider with coupons, or special coupons, there currently is often no information, or not complete enough information, available to the coupon provider about a given consumer to enable the coupon provider to accurately identify the consumer as a desirable consumer. In addition, even in the few cases where the limited information about a given consumer is available, the information is typically obtained from a single source, such as transactional data associated with a single credit card account, and is therefore incomplete, and the information is typically only available to larger retailers, advertisers and other coupon providers, such as the retailer offering the credit card account that is the single source of information.

As a result of the situation discussed above, not only are coupon providers denied the ability to identify and target particularly desirable consumers for coupon distribution, but the desirable consumers are also denied savings that would otherwise be provided to them through the coupons, if the information were available to identify them. Consequently, the current situation represents a disservice to both coupon providers and consumers.

### SUMMARY

In accordance with one embodiment, a method and system for providing coupons to select consumers includes a process for providing coupons to select consumers whereby, in one embodiment, a coupon provider defines one or more coupon eligibility criterion that must be met by a consumer in order for the consumer to be eligible to receive one or more coupons. In one embodiment, the data representing the one or more coupon eligibility criterion is then provided to the process for providing coupons to select consumers. In one embodiment, a consumer's financial data is obtained from one or more sources using a computing system implemented financial management system. In one embodiment, using the consumer's financial data and the data representing the one or more coupon eligibility criterion, one or more coupons are identified that the consumer is eligible to receive. In one embodiment, the consumer is then provided access to the one or more coupons identified that the consumer is eligible to receive.

In one embodiment, a coupon provider defines one or more coupon eligibility criterion in order to target select consumers having characteristics the coupon provider finds particularly desirable. For instance, in one embodiment, the coupon provider criteria can include, but are not limited to: consumer's who have made purchases from one or more identified product and/or service providers, such as competitors of the coupon provider; consumers who spend a defined threshold amount of money in a defined time frame in a specific category of store, such as $100.00 or more per month in a specific category of store; consumers who spend a defined threshold amount of money in a defined time frame on specific products and/or services, such as $100.00 or more per month on specific products and/or services; consumers who shop with the coupon provider, or other identified product and/or service providers a threshold number of times over a defined time frame, such as regular customer's of the coupon provider or consumers who shop 3 times or more a month at an identified product and/or service provider; consumers who have recently purchased specific products and/or services, such as products and/or services related to the products and/or services offered by the coupon provider; consumers who shop in a defined geographic location; consumers who have a defined income and/or discretionary spending budget; consumers who meet various economic and social demographics; and/or any other criteria considered desirable by a coupon provider.

In one embodiment, access to the data representing the one or more coupon eligibility criterion is then provided to the process for providing coupons to select consumers, either directly or through a computing system implemented financial management system that implements, includes, is accessible by, and/or is otherwise associated with the process for providing coupons to select consumers.

Herein, a computing system implemented financial management system can be, but is not limited to, any of the following: a computing system implemented personal financial management system; a computing system implemented home inventory system; a computing system implemented business inventory system; a computing system implemented point-of-sale system; a computing system implemented personal asset management system; a computing system implemented business asset management system; a computing system implemented personal accounting system; a computing system implemented business accounting system; a computing system implemented tax preparation system; and/or any of the numerous computing system implemented financial management systems known to those of skill in the art.

In one embodiment, a consumer's financial data is then obtained from one or more sources using a computing system implemented financial management system. As discussed below, current computing system implemented financial management systems are typically software applications which, along with a parent computing system or device, help consumers/users manage their finances, by providing a centralized interface with banks, credit card companies, asset account providers, mortgage companies, retirement account providers and other various financial and asset management institutions and/or accounts, for identifying, processing, storing, and categorizing user financial transactions. Currently, computing system implemented financial management systems typically obtain financial transaction information, such as payee identification, payee location, payment amount, date of the transaction, time of transaction, etc., via communication with banks, credit card providers, or other financial institutions, using data entry, links to databases, and electronic data transfer systems such as the Open Financial Exchange (OFX) specification, Web Direct, or various systems for transferring financial transaction data.

Using computing system implemented financial management systems, the financial transaction information, payee identification, payee location, payment amount, date of the transaction, and other data is often used by the computing system implemented financial management system to categorize individual financial transactions as a particular type of income or expense, to generate various financial reports, and to create an overview of the consumer's financial situation based on input from multiple, and often all, available sources of financial information regarding a given consumer. Some currently offered computing system implemented financial management systems then use this financial transaction information to track events, such as purchase events, and to provide various historical data reports or displays including “to date” data reports such as historical spending data reports in one or more particular categories.

In one embodiment, the consumer's financial data and the data representing the one or more coupon eligibility criterion is then processed to match and/or identify one or more coupons that the consumer is eligible to receive.

In one embodiment, the consumer is then provided access to the one or more coupons identified that the consumer is eligible to receive. In one embodiment, the consumer is provided access to the one or more coupons identified by storing data representing the one or more coupons identified in an account associated with the consumer and then providing the consumer access to the account and the data, either directly or through a computing system implemented financial management system. In one embodiment, the consumer is provided access to the one or more coupons identified by transferring data representing the one or more coupons identified that the consumer is eligible to receive to the consumer, either directly or through a computing system implemented financial management system. In one embodiment, the consumer is provided access to the one or more coupons identified that the consumer is eligible to receive by transferring the data to, and/or providing access to the data, representing the one or more coupons to the consumer through a computing system implemented financial management system and within the context of one or more financial transactions considered relevant to the one or more coupons by the coupon provider and/or the provider of the process for providing coupons to select consumers.

Using the method and system for providing coupons to select consumers disclosed herein, a coupon provider is given the ability to distribute coupons to select consumers who meet the coupon eligibility criteria defined by the coupon provider. Using the method and system for providing coupons to select consumers disclosed herein, consumers meeting the coupon eligibility criteria are identified using financial data from various sources as obtained using a computing system implemented financial management system. Therefore, using the method and system for providing coupons to select consumers disclosed herein, consumers meeting the coupon eligibility criteria are identified based on more complete financial data than is typically currently available through any one source of financial data.

In addition, in one embodiment, the consumer is provided access to one or coupons he or she is eligible for through a computing system implemented financial management system, and within the context of relevant financial transaction data.

Consequently, using the method and system for providing coupons to select consumers disclosed herein, the coupon providers are able to target select consumers based on more complete and accurate information, and provide those consumers selected one or more coupons within a relevant context. As a result, not only are the coupon providers given the ability to identify and target particularly desirable consumers for coupon distribution, but the desirable consumers are also provided savings that would likely not be provided to them absent the method and system for providing coupons to select consumers disclosed herein.

As discussed in more detail below, using the below embodiments, with little or no modification and/or user input, there is considerable flexibility, adaptability, and opportunity for customization to meet the specific needs of various users under numerous circumstances.

### BRIEF DESCRIPTION OF THE DRAWINGS

FIG. 1 is a block diagram of an exemplary hardware architecture for implementing one embodiment;

FIG. 2 is a flow chart depicting a process for providing coupons to select consumers in accordance with one embodiment;

FIG. 3 is a flow chart depicting a process for providing coupons to select consumers in accordance with one embodiment;

FIG. 4A shows one embodiment of a portion of a transaction ledger generated by a computing system implemented financial management system including a coupon offer, in accordance with one embodiment; and

FIG. 4B shows one embodiment of a portion of a transaction ledger generated by a computing system implemented financial management system including a coupon offer and coupon description, in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be embodied in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

For illustrative purposes, some embodiments are described herein within the framework of, and using, one or more computing system implemented financial management systems. Various specific details are discussed below, and shown in the accompanying FIG.s, to aid one of skill in the art in understanding the invention. However, such specific details are intended to be illustrative only, and are not intended to restrict in any way the scope as claimed herein. In addition, the particular terminology used herein is intended to be illustrative and exemplary only, and in no way limits the scope as claimed.

Some embodiments are implemented in a computing system including a conventional computing system running a conventional operating system such as those distributed by Microsoft Corporation of Redmond Wash.; Apple Computer Inc. of Cupertino Calif.; any Unix operating system; any Linux operating system; the Palm OS series of operating systems; or any other operating system designed to generally manage operations on a computing system, whether known at the time of filing or as developed later. Some embodiments are implemented in a mobile computing system running mobile operating systems such as Symbian® OS, Windows® Mobile, or any other operating system designed to generally manage operations on a mobile computing system, whether known at the time of filing or as developed later. As described more fully below, embodiments can be implemented on computing systems other than a conventional computing system such as, for example, a personal digital assistant, a cell phone, or other computing system capable of processing computer readable data, whether known at the time of filing or as developed later. Computing systems also include those in which one or more computing resources (hardware or software) are located remotely and accessed via network, such as a Local Area Network (LAN), Wide Area Network (WAN), a public network, such as the Internet, a private network, a combination of network types, a computing system bus, or other electronic medium in which data may be exchanged between one computing system and one or more other computing system(s), whether known at the time of filing or as developed later. Embodiments may be included as add-on software for existing software programs, packages or applications, and embodiments may be a feature of an application that is bundled with a computing system or sold separately. Some embodiments may also be implemented as functionality embedded in hardware devices and systems.

Output generated by one or more embodiments can be displayed on a display screen, delivered from a website and/or web-based function, transmitted to a remote device, stored on any database, computer server or other storage mechanism, printed, or used in any other way. In addition, in some embodiments, processes and/or systems described herein may make use of input provided to the computer device implementing a process and/or application, discussed herein, via user interface devices such as a keyboard, mouse, touchpad, or any other device capable of providing user input to a computing system or for translating user actions into computing system operations, whether known at the time of filing or as developed later.

### Hardware System Architecture

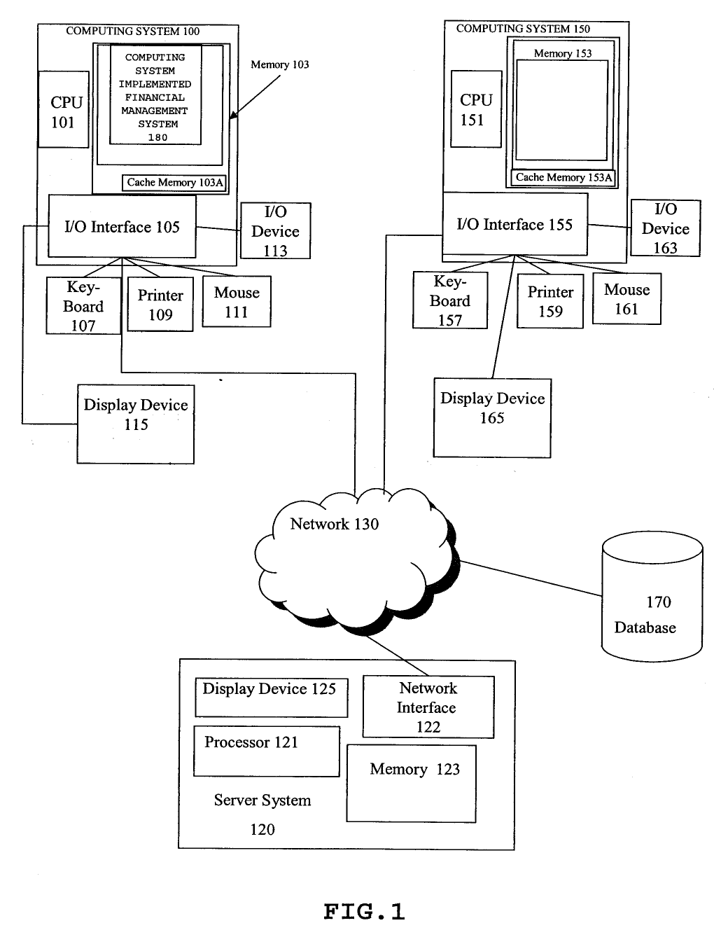

FIG. 1 is a block diagram of an exemplary hardware architecture for implementing one embodiment of a system and method for providing coupons to select consumers, such as exemplary processes 200 and 300 discussed herein, that includes: a computing system 100, e.g., a first computing system; a computing system 150, e.g., a second computing system; a server system 120; and a database 170, all operatively coupled by a network 130.

As seen in FIG. 1, computing system 100 typically includes a central processing unit (CPU) 101, an input/output (I/O) interface 105, and a memory system 103, including cache memory 103A. In one embodiment, memory system 103 includes all, or part of, a computing system implemented financial management system 180 such as, but not limited to: a computing system implemented personal financial management system; a computing system implemented business financial management system; a computing system implemented personal accounting system; a computing system implemented business accounting system; a computing system implemented tax preparation system; a computing system implemented healthcare management system; or any other computing system implemented personal and/or business data management system. In one embodiment, computing system implemented financial management system 180 is stored, in whole, or in part, in memory system 103, and is used by, or includes, as discussed below, a process for providing coupons to select consumers, such as exemplary processes 200 and 300 discussed below.

Computing system 100 may further include standard user interface devices such as a keyboard 107, a mouse 111, a printer 109, and a display device 115, as well as, one or more standard input/output (I/O) devices 113, such as a compact disk (CD) or Digital Video Disc (DVD) drive, floppy disk drive, or other digital or waveform port, or other device capable of inputting data to, and outputting data from, computing system 100, whether available or known at the time of filing or as later developed. As discussed in more detail below, in one embodiment, a process for providing coupons to select consumers and/or a computing system implemented financial management system are entered, in whole, or in part, into computing system 100 via I/O device 113, such as from a CD, DVD, floppy disk, portable hard drive, memory stick, download site, or other medium and/or computer program product as defined herein.

In one embodiment, computing system 100 is a computing system accessible by a consumer and used and/or accessible by another computing system, such as computing system 150 (discussed below), a workstation, a two-way pager, a cellular telephone, a smart phone, a digital wireless telephone, a Personal Digital Assistant (PDA), a server computer, an Internet appliance, any other device, or any desired combination of these devices, that includes components that can execute all, or part, of a process for providing coupons to select consumers, and/or a computing system implemented financial management system, in accordance with at least one of the embodiments as described herein.

Similarly, computing system 150 typically includes a CPU 151, an input/output (I/O) interface 155, and a memory system 153, including cache memory 153A. Similar to computing system 100, computing system 150 may further include standard user interface devices such as a keyboard 157, a mouse 161, a printer 159, and a display device 165, as well as, one or more standard input/output (I/O) devices 163, such as a compact disk (CD) or DVD drive, floppy disk drive, or other digital or waveform port, or other device capable of inputting data to, and outputting data from, computing system 150, whether available or known at the time of filing or as later developed.

In one embodiment, computing system 150 is accessible by a coupon provider and, in one embodiment, memory system 153 includes all, or part of, data representing the one or more coupon eligibility criterion, such as, those discussed below.

As discussed in more detail below, in one embodiment, all, or part of, a process for providing coupons to select consumers, and/or a computing system implemented financial management system, can also be loaded, in whole, or in part, into computing system 150 from computing system 100 for storage in memory system 153 and/or cache memory 153A.

Also shown in FIG. 1 is exemplary database 170. In one embodiment, database 170 is a data storage device, a designated server system or computing system, or a designated portion of one or more server systems or computing systems, such as computing systems 100, 150 and 120, or a distributed database, or an external and/or portable hard drive. In one embodiment, database 170 is a dedicated mass storage device implemented in software, hardware, or a combination of hardware and software. In one embodiment, database 170 is a web-based function. As discussed in more detail below, in one embodiment, database 170 is under the control of the consumer, and/or the consumer's agents, and/or a process for providing coupons to select consumers, such as exemplary processes 200 and 300, and/or a computing system implemented process, such as a computing system implemented financial management system 180.

In one embodiment, database 170 is used, controlled, and/or accessible by, a provider of and/or a system and process for providing coupons to select consumers, such as processes for providing coupons to select consumers 200 and/or 300 and data representing all, or part, of a consumer's financial data is stored in database 170, typically in accounts associated with a given consumer. In one embodiment, database 170 is used, controlled, and/or accessible by, a provider of and/or a computing system implemented financial management system, such as a computing system implemented financial management system 180, and data representing all, or part, of a consumer's financial data is stored in database 170, typically in accounts associated with a given consumer. In one embodiment, database 170 is used, controlled, and/or accessible by, one or more coupon providers and all, or part of, data representing the one or more coupon eligibility criterion, such as, those discussed below, is stored in database 170. In one embodiment all, or part of, data representing the one or more coupons a consumer is eligible to receive, such as discussed below, is stored in accounts associated with a given consumer on database 170.

In one embodiment, computing systems 100 and 150, and database 170, are coupled to a server system 120 through network 130. In one embodiment, server system 120 typically includes a server system display device 125, a server system processor 121, a server system memory 123, and a server system network interface 122.

In one embodiment, server system 120 is used in a station-to-station arrangement, such as a peer-to-peer, or hybrid peer-to peer, arrangement, as an indexing and/or central server used to connect a first computing system, such as computing system 100, and a second computing system, such as computing system 150.

In one embodiment, server system 120 is used, controlled, and/or accessible by, a provider of and/or a system and process for providing coupons to select consumers, such as processes for providing coupons to select consumers 200 and/or 300 and data representing all, or part, of a consumer's financial data is stored in server system 120, typically in accounts associated with a given consumer. In one embodiment, server system 120 is used, controlled, and/or accessible by, a provider of and/or a computing system implemented financial management system, such as a computing system implemented financial management system 180, and data representing all, or part, of a consumer's financial data is stored in server system 120, typically in accounts associated with a given consumer. In one embodiment, server system 120 is used, controlled, and/or accessible by, one or more coupon providers and all, or part of, data representing the one or more coupon eligibility criterion, such as those discussed below, is stored in server system 120. In one embodiment all, or part of, data representing the one or more coupons a consumer is eligible to receive, such as discussed below, is stored in accounts associated with a given consumer on server system 120. Network 130 can be any network or network system that is of interest to a user such as, a peer-to-peer network, a hybrid peer-to-peer network, a Local Area Network (LAN), a Wide Area Network (WAN), a public network, such as the Internet, a private network, a combination of different network types, or other wireless, wired, and/or a wireless and wired combination network capable of allowing communication between two or more computing systems, whether available or known at the time of filing or as later developed.

Those of skill in the art will readily recognize that the components shown in FIG. 1, such as computing systems 100 and 150, database 170, server system 120, and their respective components, are shown for illustrative purposes only and that architectures with more or fewer components can implement, and benefit from, the invention. Moreover, one or more components of computing system 100, computing system 150, database 170, and server system 120 may be located remotely from their respective system and accessed via network, as discussed herein. In addition, the particular type of, and configuration of, computing systems 100 and 150, database 170, and server system 120 are not relevant.

As discussed in more detail below, in one embodiment, a process for providing coupons to select consumers, such as processes for providing coupons to select consumers 200 and/or 300, and/or a computing system implemented financial management system, such as a computing system implemented financial management system 180, and/or data representing the one or more coupon eligibility criterion, such as discussed below, and/or data representing the one or more coupons a consumer is eligible to receive, such as discussed below, are stored, in whole, or in part, in memory system 103 and/or cache memory 103A, of computing system 100, and/or memory system 153 and/or cache memory 153A of computing system 150, and/or in server memory system 123 of server system 120 and/or in database 170, and executed on computing system 100 and/or computing system 150. As used herein, a memory refers to a volatile memory, a non-volatile memory, or any combination of the two.

Although a process for providing coupons to select consumers, such as processes for providing coupons to select consumers 200 and/or 300, and/or a computing system implemented financial management system, such as computing system implemented financial management system 180, are sometimes referred to herein, alternatively, as a process, an application, a module, a program, a component of a software system, a component of a software package, a component of a parent system, a plug-in, or a feature of a parent system, this terminology is illustrative only. In some embodiments, a process for providing coupons to select consumers, such as processes for providing coupons to select consumers 200 and/or 300, and/or a computing system implemented financial management system, such as a computing system implemented financial management system 180, are capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as CPUs 101 and 151, or server system processor 121. In one embodiment, execution of a process by CPU 101, CPU 151, or server system processor 121, results in the operations of an agent computer process (not shown) and/or a rule computer process (not shown).

In one embodiment, a process for providing coupons to select consumers, such as processes for providing coupons to select consumers 200 and/or 300, and/or a computing system implemented financial management system, such as a computing system implemented financial management system 180, and/or data representing the one or more coupon eligibility criterion, such as discussed below, and/or data representing the one or more coupons a consumer is eligible to receive, such as discussed below, are computer applications or processes and/or data implemented and/or run and/or stored, in full, or in part, in, or on, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, such as server system 120 of FIG. 1, and signals transmitted over a network, such as network 130 of FIG. 1, or other media or process capable of delivering computer readable data representing computer readable code, whether available or known at the time of filing or as later developed. This medium may belong to a computing system, such as computing systems 100 and 150 of FIG. 1, described above. However, in some embodiments, the medium also may be removable and/or remote from the computing system.

For example, all, or part, of a process for providing coupons to select consumers, such as processes for providing coupons to select consumers 200 and/or 300, and/or a computing system implemented financial management system, such as a computing system implemented financial management system 180, and/or data representing the one or more coupon eligibility criterion, such as discussed below, and/or data representing the one or more coupons a consumer is eligible to receive, such as discussed below, may be stored in a memory that is physically located in a location, such as server system memory 123, or database 170, of FIG. 1, different from a computing system, such as computing systems 100 and/or 150 of FIG. 1, utilizing a process for providing coupons to select consumers, and/or a computing system implemented financial management system, data representing the one or more coupon eligibility criterion, such as discussed below, and/or data representing the one or more coupons a consumer is eligible to receive, such as discussed below. In one embodiment, all, or part, of a process for providing coupons to select consumers, and/or a computing system implemented financial management system, and/or data representing the one or more coupon eligibility criterion, such as discussed below, and/or data representing the one or more coupons a consumer is eligible to receive, such as discussed below, may be stored in a memory that is physically located, separate from the computing system's processor(s), such as CPUs 101 and 151 of FIG. 1, and the computing system CPUs can be coupled to the memory in a client-server system, such as server system 120 of FIG. 1, or, alternatively, via connection to another computer, such as computing systems 100, 150 of FIG. 1, via modems and analog lines, digital interfaces and a digital carrier line, or wireless or cellular connections.

In one embodiment, the computing systems and/or server systems, such as computing systems 100 and/or 150 and/or server system 120 of FIG. 1, running and/or utilizing and/or storing all, or part, of a process for providing coupons to select consumers, such as processes for providing coupons to select consumers 200 and/or 300, and/or a computing system implemented financial management system, such as a computing system implemented financial management system 180, and/or data representing the one or more coupon eligibility criterion, such as discussed below, and/or data representing the one or more coupons a consumer is eligible to receive, such as discussed below, is a portable computer, a workstation, a two-way pager, a cellular telephone, a smart phone, a digital wireless telephone, a PDA, a server computer, an Internet appliance, or any other device that includes components that can execute all, or part, of a process for providing coupons to select consumers, and/or a computing system implemented financial management system, in accordance with at least one of the embodiments as described herein. Similarly, in another embodiment, a process for providing coupons to select consumers, and/or a computing system implemented financial management system, and/or data representing the one or more coupon eligibility criterion, such as discussed below, and/or data representing the one or more coupons a consumer is eligible to receive, such as discussed below, may be implemented on, and/or run, and/or stored on, a computing system and/or server system that is comprised of multiple different computers, wireless devices, cellular telephones, digital telephones, two-way pagers, personal digital assistants, server computers, or any desired combination of these devices, that are coupled to perform the processes and/or operations as described herein.

### Process

Herein, the terms “consumer”, “individual”, “user”, and/or “customer” are used interchangeably to denote any party interfacing and/or interacting with a process for providing coupons to select consumers, and/or a person who is the subject of, and/or target of, all, or part of, any data/information obtained by a process for providing coupons to select consumers, and/or a legal guardian of a person who is the subject of, and/or target of, any data/information obtained by a process for providing coupons to select consumers, and/or an authorized agent of any party interfacing and/or interacting with a process for providing coupons to select consumers, and/or a person who is the subject of, and/or target of, any information obtained by a process for providing coupons to select consumers, and/or any other authorized party associated with any party interfacing and/or interacting with a process for providing coupons to select consumers, and/or a person who is the subject of, and/or target of, any information obtained by a process for providing coupons to select consumers.

Herein, the term “coupon” is used to denote coupons, discount certificates, discount vouchers, sales offers, and/or any other marketing tool and/or device that is presented and/or offered to a consumer.

As used herein, the term computing system implemented financial management system includes, but is not limited to: computing system implemented personal and small business financial management systems, packages, programs, modules, or applications; computing system implemented business systems, packages, programs, modules, or applications; computing system implemented tax preparation systems, packages, programs, modules, or applications; computing system implemented accounting and/or invoicing systems, packages, programs, modules, or applications; and various other electronic transaction driven data management systems, packages, programs, modules, or applications, whether known at the time of filling or as developed later.

In accordance with one embodiment, a method and system for providing coupons to select consumers includes a process for providing coupons to select consumers whereby, in one embodiment, a coupon provider defines one or more coupon eligibility criterion that must be met by a consumer in order for the consumer to be eligible to receive one or more coupons. In one embodiment, access to the data representing the one or more coupon eligibility criterion is then provided to the process for providing coupons to select consumers. In one embodiment, a consumer's financial data is obtained from one or more sources using a computing system implemented financial management system. In one embodiment, using the consumer's financial data and the data representing the one or more coupon eligibility criterion, one or more coupons are identified that the consumer is eligible to receive. In one embodiment, the consumer is then provided access to the one or more coupons identified that the consumer is eligible to receive.

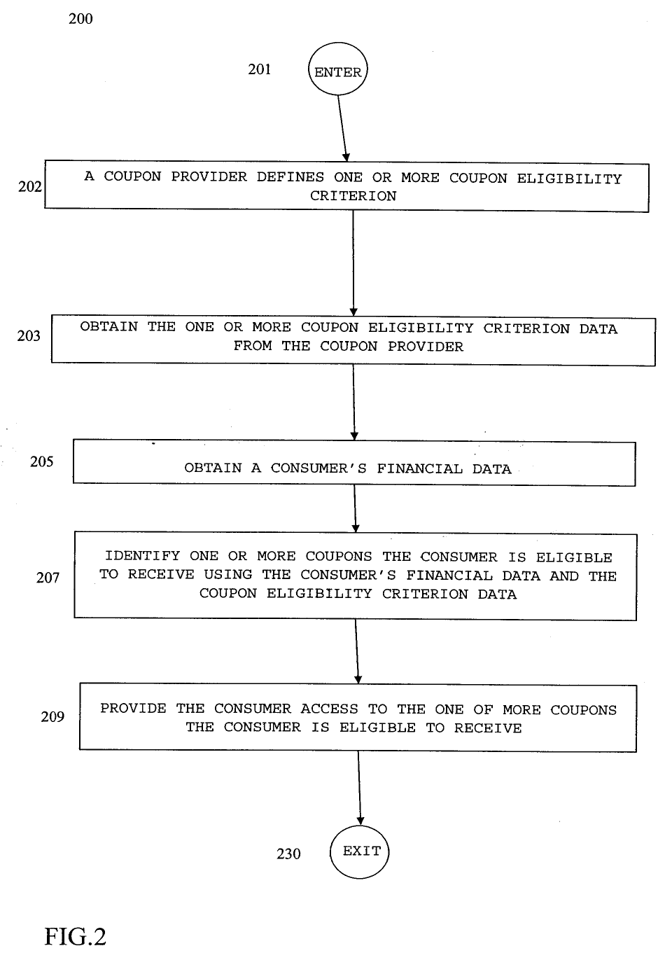

FIG. 2 a flow chart depicting a process for providing coupons to select consumers 200 in accordance with one embodiment. Process for providing coupons to select consumers 200 begins at ENTER OPERATION 201 of FIG. 2 and process flow proceeds to A COUPON PROVIDER DEFINES ONE OR MORE COUPON ELIGIBILITY CRITERION OPERATION 202.

In one embodiment, at A COUPON PROVIDER DEFINES ONE OR MORE COUPON ELIGIBILITY CRITERION OPERATION 202 a coupon provider defines one or more coupon eligibility criterion that must be met by a consumer in order for the consumer to be eligible to receive one or more coupons.

In one embodiment, a coupon provider defines one or more coupon eligibility criterion at A COUPON PROVIDER DEFINES ONE OR MORE COUPON ELIGIBILITY CRITERION OPERATION 202 in order to target select consumers having characteristics the coupon provider finds particularly desirable or particularly relevant to one or more selected coupons. In one embodiment, virtually any criteria can be defined by the coupon provider. For instance, in one embodiment, the coupon provider defined eligibility criteria can include, but is not limited to, consumer's who have made purchases from one or more identified product and/or service providers. Using this criterion, the coupon provider can select consumers who have historically made purchases from competitors of the coupon provider allowing the coupon provider the opportunity to lure the consumer away from the competitors with special coupons and offers.

As another example, in one embodiment, the coupon provider defined eligibility criteria can include, but is not limited to, consumers who spend a defined threshold amount of money, in one example, in a defined time frame, in a specific category of store. Using this criterion the coupon provider can target select consumers who are likely to yield a desired return on the coupon investment and are possibly patrons of the coupon provider's competition. As one example, a coupon provider may target consumers who spend $100.00 or more per month in a specific category of store, typically the coupon provider's store category.

As another example, in one embodiment, the coupon provider defined eligibility criteria can include, but is not limited to, consumers who spend a defined threshold amount of money, in one embodiment, in a defined timeframe, on specific products and/or services. Using this criterion the coupon provider can target select consumers who are likely to yield a desired return on the coupon investment and may also be patrons of the coupon provider's competitors. As one example, a coupon provider may target consumers who spend $100.00 or more per month on specific products and/or services, typically those offered by, or related to, products and/or services offered by the coupon provider.

As another example, in one embodiment, the coupon provider defined eligibility criteria can include, but is not limited to, consumers who shop with the coupon provider, or other identified product and/or service providers, a threshold number of times, in one embodiment, over a defined time frame. Using this criterion the coupon provider can target select consumers who are repeat customers, as a loyalty reward, or consumers who are likely to yield a desired return on the investment and may also be patrons of the coupon provider's competitors. In addition, this criterion can be used to distribute a customer loyalty reward in view of a market share threat, such as a new competitor opening up down the street, or an established competitor having a sale.

As another example, in one embodiment, the coupon provider defined eligibility criteria can include, but is not limited to, consumers who have recently purchased specific products and/or services related to the products and/or services offered by the coupon provider. Using this criterion the coupon provider can target select consumers who are determined likely to make defined product and/or service purchases in the near future that are related to, and/or complement, recent consumer purchases. For instance, a coupon provider who sells home theater sound systems may wish to target consumer's who recently purchased big screen TVs with special coupons and/or offers.

As another example, in one embodiment, the coupon provider defined eligibility criteria can include, but is not limited to, consumers who have a defined income and/or discretionary spending budget. Using this criterion the coupon provider can target select consumers who are likely to yield a desired return on the investment.

As another example, in one embodiment, the coupon provider defined eligibility criteria can include, but is not limited to, consumers who shop in a defined geographic location. Using this criterion the coupon provider can target select consumers who historically shop in the coupon provider's area, or a competitor's area.

As another example, in one embodiment, the coupon provider defined eligibility criteria can include, but is not limited to, consumers who meet various economic and social demographics. Using this criterion the coupon provider can target select consumers who are likely to yield a desired return on the investment and may have special, or increased, interest in one or more of the coupon provider's products and/or services.

The specific coupon provider defined eligibility criteria discussed above are but a few specific examples of possible coupon provider defined eligibility criteria. In other embodiments, any other criteria, or combination of criteria, considered desirable by a coupon provider can be defined at A COUPON PROVIDER. DEFINES ONE OR MORE COUPON ELIGIBILITY CRITERION OPERATION 202.

In one embodiment, once a coupon provider defines one or more coupon eligibility criterion that must be met by a consumer in order for the consumer to be eligible to receive one or more coupons at A COUPON PROVIDER DEFINES ONE OR MORE COUPON ELIGIBILITY CRITERION OPERATION 202, process flow proceeds to OBTAIN THE ONE OR MORE COUPON ELIGIBILITY CRITERION DATA FROM THE COUPON PROVIDER OPERATION 203.

In one embodiment, at OBTAIN THE ONE OR MORE COUPON ELIGIBILITY CRITERION DATA FROM THE COUPON PROVIDER OPERATION 203, data representing the one or more coupon eligibility criterion of A COUPON PROVIDER DEFINES ONE OR MORE COUPON ELIGIBILITY CRITERION OPERATION 202 is provided to process for providing coupons to select consumers 200.

In one embodiment, at OBTAIN THE ONE OR MORE COUPON ELIGIBILITY CRITERION DATA FROM THE COUPON PROVIDER OPERATION 203 access to the data representing the one or more coupon eligibility criterion is provided to process for providing coupons to select consumers 200, either directly, or through a computing system implemented financial management system that implements, includes, is accessible by, and/or is otherwise associated with the process for providing coupons to select consumers.

In one embodiment, access to the data representing the one or more coupon eligibility criterion is provided to process for providing coupons to select consumers 200 at OBTAIN THE ONE OR MORE COUPON ELIGIBILITY CRITERION DATA FROM THE COUPON PROVIDER OPERATION 203 by providing process for providing coupons to select consumers 200, and/or a computing system implemented financial management system associated with process for providing coupons to select consumers 200, access to the data on a database, such as database 170 of FIG. 1, a computing system, such as computing systems 100 and/or 150 of FIG. 1, and/or a server system, such as server system 120 of FIG. 1, or a web-site or other web-based system, and/or using a computer program product as defined herein.

Returning to FIG. 2, in one embodiment, access to the data representing the one or more coupon eligibility criterion is provided to process for providing coupons to select consumers 200, and/or a computing system implemented financial management system associated with process for providing coupons to select consumers 200, at OBTAIN THE ONE OR MORE COUPON ELIGIBILITY CRITERION DATA FROM THE COUPON PROVIDER OPERATION 203 through a network of computing systems and/or server systems that is comprised of multiple different computers, wireless devices, cellular telephones, digital telephones, two-way pagers, personal digital assistants, server computers, or any desired combination of these devices, that are interconnected using a network, such as network 130 of FIG. 1. As discussed above, network 130 can be any network or network system that is of interest to a user such as a Local Area Network (LAN), a Wide Area Network (WAN), a public network, such as the Internet, a private network, a combination of network types, or any other network capable of allowing communication between two or more computing systems, whether available or known at the time of filing or as later developed.

Returning to FIG. 2, in one embodiment, access to the data representing the one or more coupon eligibility criterion is provided to process for providing coupons to select consumers 200, and/or a computing system implemented financial management system associated with process for providing coupons to select consumers 200, at OBTAIN THE ONE OR MORE COUPON ELIGIBILITY CRITERION DATA FROM THE COUPON PROVIDER OPERATION 203 through e-mail or through text messaging.

In one embodiment, access to the data representing the one or more coupon eligibility criterion is provided to process for providing coupons to select consumers 200, and/or a computing system implemented financial management system associated with process for providing coupons to select consumers 200, at OBTAIN THE ONE OR MORE COUPON ELIGIBILITY CRITERION DATA FROM THE COUPON PROVIDER OPERATION 203 using any method, apparatus, process or mechanism for transferring data, images, screen displays, and/or text from one or more devices, computing systems, server systems, databases, web site/web functions and/or any devices having a data storage capability to one or more other devices, computing systems, server systems, databases, web site/web functions and/or any devices having a data storage and/or display capability, whether known at the time of filing or as thereafter developed.

In one embodiment, once data representing the one or more coupon eligibility criterion is provided to process for providing coupons to select consumers 200 at OBTAIN THE ONE OR MORE COUPON ELIGIBILITY CRITERION DATA FROM THE COUPON PROVIDER OPERATION 203, process flow proceeds to OBTAIN A CONSUMER'S FINANCIAL DATA OPERATION 205.

In one embodiment, at OBTAIN A CONSUMER'S FINANCIAL DATA OPERATION 205 a consumer's financial data is obtained from one or more sources using a computing system implemented financial management system.

In one embodiment, at OBTAIN A CONSUMER'S FINANCIAL DATA OPERATION 205 financial data representing various financial transactions conducted by a given consumer is obtained by process for providing coupons to select consumers 200 using/from a computing system implemented financial management system.

In one embodiment, the data representing financial transactions conducted by a given consumer obtained at OBTAIN A CONSUMER'S FINANCIAL DATA OPERATION 205 includes data associated with financial transactions conducted using multiple payment methods to provide as complete a set of consumer financial data as possible.

For instance, in one embodiment, the consumer's financial transaction data is obtained at OBTAIN A CONSUMER'S FINANCIAL DATA OPERATION 205 from, but not limited to, any one or more of the following sources: banks; debit cards and/or accounts; credit unions; credit cards and/or accounts and/or credit card/account providers; asset accounts and/or asset account providers; or other financial resources, accounts and/or services used by a consumer to pay for and/or conduct financial transactions.

In addition, in some embodiments, the consumer's financial transaction data obtained at OBTAIN A CONSUMER'S FINANCIAL DATA OPERATION 205 is obtained from multiple sources of the same type. For instance, in one embodiment, the consumer's financial transaction data is obtained at OBTAIN A CONSUMER'S FINANCIAL DATA OPERATION 205 from: two or more banks; two or more debit cards and/or accounts; two or more credit unions; two or more credit cards and/or accounts and/or credit card/account providers; two or more asset accounts and/or asset account providers; and/or two or more other financial resources, accounts and/or services used by a consumer to pay for and/or conduct financial transactions.

As noted above, in one embodiment, all, or part, of the consumer's financial transaction data is obtained by process for providing coupons to select consumers 200 at OBTAIN A CONSUMER'S FINANCIAL DATA OPERATION 205 from, or using, a computing system implemented financial management system, such as computing system implemented financial management system 180, that implements, includes, is accessed by, and/or is otherwise associated with process for providing coupons to select consumers 200 (FIG. 2).

Currently, various computing system implemented financial management systems are available including: computing system implemented personal financial management systems; computing system implemented small business financial management systems; computing system implemented home inventory systems; computing system implemented tax preparation systems; computing system implemented business accounting systems; and computing system implemented medical expense management systems; as well as various other electronic transaction data driven financial management systems.

Computing system implemented financial management systems typically help consumers/users manage their finances by providing a centralized interface with banks, credit card companies, and other various financial institutions and/or accounts, for identifying, processing, storing, and categorizing consumer financial transactions and other consumer financial data. Currently, computing system implemented financial management systems typically obtain financial transaction information, such as payee identification, payee location, payment amount, date of the transaction, time of transaction, items purchased, the type of transaction, etc., via communication with banks, credit card providers, or other financial institutions, using electronic data transfer systems such as the Open Financial Exchange (OFX) specification, Web Direct, or various other systems for transferring financial transaction data.

As noted above, using computing system implemented financial management systems, the financial transaction information, payee identification, payee location, payment amount, date of the transaction, and other data is often used by the computing system implemented financial management system to categorize individual financial transactions as a particular type of income or expense. Some currently offered computing system implemented financial management systems then use this financial transaction information to track events, such as purchase events, and to provide various historical data reports or displays including “to date” data reports such as historical spending data reports in one or more particular categories.

In one embodiment, the consumer's financial transaction data obtained using one or more computing system implemented financial management systems is transferred, or otherwise made available to, process for providing coupons to select consumers 200 at OBTAIN A CONSUMER'S FINANCIAL DATA OPERATION 205.

In one embodiment, all, or part, of the consumer's financial transaction data is obtained by process for providing coupons to select consumers 200 at OBTAIN A CONSUMER'S FINANCIAL DATA OPERATION 205 from invoices/bills and/or receipt data provided to process for providing coupons to select consumers 200, and/or an associated computing system implemented financial management system, by one or more merchants and/or product and/or service providers. In one embodiment, the invoice/bill and/or receipt data includes “level 3” data indicating, among other things, the line item entry and product and/or service identification for each item purchased in the transaction.

As noted above, in one embodiment, process for providing coupons to select consumers 200 is associated with a computing system implemented financial management system, such as computing system implemented financial management system 180 of FIG. 1, that implements, includes, is accessed by, and/or is otherwise associated with process for providing coupons to select consumers 200 (FIG. 2). Some of these computing system implemented financial management systems provide the capability to obtain, receive, and/or process electronic copies of the invoices/receipts from one or more merchants and/or product and/or service providers, often in their specific formats, and then store the data for use by process for providing coupons to select consumers 200 in one of numerous locations by one of numerous methods known to those of skill in the art and/or as discussed herein.

In one embodiment, all, or part, of the consumer's financial transaction data is obtained by process for providing coupons to select consumers 200, and/or a computing system implemented financial management system, at OBTAIN A CONSUMER'S FINANCIAL DATA OPERATION 205 from one or more of the following, either directly, or by using screen scraping technology, or a similar technology: websites sponsored by, controlled by, or associated with banks, debit cards and/or accounts, credit unions, credit cards and/or accounts, and/or credit card/account providers, asset accounts and/or asset account providers, or other financial resources, accounts and/or services used by a consumer to pay for and/or conduct financial transactions; and/or computing system implemented applications sponsored by, controlled by, or associated with banks, debit cards and/or accounts, credit unions, credit cards and/or accounts, and/or credit card/account providers, asset accounts and/or asset account providers, or other financial resources, accounts and/or services used by a consumer to pay for and/or conduct financial transactions.

In one embodiment, all, or part, of the consumer's financial transaction data is obtained by process for providing coupons to select consumers 200 at OBTAIN A CONSUMER'S FINANCIAL DATA OPERATION 205 from user input through a user interface device such as keyboard 107, 157, mouse 111, 161 of FIG. 1 or a touchpad, voice command recognition system, or any other device capable of providing user input to a computing system or for translating user actions into computing system operations, whether available or known at the time of filing or as developed later.

Returning to FIG. 2, in one embodiment, all, or part, of the consumer's financial transaction data is obtained by process for providing coupons to select consumers 200 at OBTAIN A CONSUMER'S FINANCIAL DATA OPERATION 205 from any combination of the above sources and/or from any other source of a consumer's financial data whether known at the time of filing or as developed thereafter.

In one embodiment, once the consumer's financial data is obtained at OBTAIN A CONSUMER'S FINANCIAL DATA OPERATION 205, the data is stored in whole, or in part, in a database maintained by, accessible by, owned by, or otherwise related to: process for providing coupons to select consumers 200, and/or a provider of process for providing coupons to select consumers 200; a computing system implemented financial management system, and/or a provider of a computing system implemented financial management system; one or more coupon providers; or any other party, by any one of the numerous mechanisms known to those of skill in the art. For instance, in one embodiment, the data, in whole, or in part, is stored in a memory system, such as memory systems 103 and 153 or server memory system 123, or database 170, of FIG. 1, or in a cache memory, such as cache memories 103A/153A of FIG. 1, or in any main memory or mass memory, associated with a computing system, such as computing systems 100 or 150 described above. In one embodiment, the data, in whole, or in part, is stored in any computing system and/or server system, such as computing systems 100 or 150 or server system 120, or other device, in another location, or on/in a computer readable medium, and/or any other computer program product, as defined herein. In one embodiment, the data, in whole, or in part, is stored on a webpage, in a web-based system or on a public network such as the Internet.

Returning to FIG. 2, in some embodiments, the consumer's financial data stored as described above is maintained, in whole, or in part, by: process for providing coupons to select consumers 200, and/or a provider of process for providing coupons to select consumers 200; a computing system implemented financial management system, and/or a provider of a computing system implemented financial management system; one or more coupon providers; a third party data storage institution; any third party service or institution; or any other parties. In these embodiments, access to the consumer's financial data is then provided to process for providing coupons to select consumers 200, and/or a computing system implemented financial management system by providing access to the data and/or providing the data on a computer program product.

In one embodiment, once a consumer's financial data is obtained from one or more sources at OBTAIN A CONSUMER'S FINANCIAL DATA OPERATION 205, process flow proceeds to IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207.

In one embodiment at IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207 the consumer's financial data of OBTAIN A CONSUMER'S FINANCIAL DATA OPERATION 205 and the data representing the one or more coupon eligibility criterion of OBTAIN THE ONE OR MORE COUPON ELIGIBILITY CRITERION DATA FROM THE COUPON PROVIDER OPERATION 203 is used to identify/determine one or more coupons that the consumer is eligible to receive.

In one embodiment, at IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207 the consumer's financial data of OBTAIN A CONSUMER'S FINANCIAL DATA OPERATION 205 and the data representing the one or more coupon eligibility criterion of OBTAIN THE ONE OR MORE COUPON ELIGIBILITY CRITERION DATA FROM THE COUPON PROVIDER OPERATION 203 is processed to match and/or identify one or more coupons that the consumer is eligible to receive using any one of numerous matching procedures, processes, methods, means, and/or mechanisms, well known in the art for process, and/or comparing, and/or matching two sets of data.

A noted above, in some embodiments, the consumer's financial data of OBTAIN A CONSUMER'S FINANCIAL DATA OPERATION 205 includes, but is not limited to: financial transaction data, such as payee identification, payee location, payment amount, date of the transaction, time of transaction, etc.; receipt information, such as level 3 line item identification receipt data; general financial data such as mortgage balances, loan balances and net worth; and various financial report data, such as gross income, net income, taxes paid, budgets, spending by category, and discretionary spending; as well as various other consumer financial data that, in many cases includes virtually all, or most, of the consumer's financial data available. Consequently, at IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207 any, or all, of the above information can be matched with the data representing the one or more coupon eligibility criterion of OBTAIN THE ONE OR MORE COUPON ELIGIBILITY CRITERION DATA FROM THE COUPON PROVIDER OPERATION 203 to identify one or more coupons that the consumer is eligible to receive based on complete, or nearly complete, consumer financial data. This is typically in contrast to systems relying on a single source of consumer financial data.

For instance, in one example, the coupon provider defined eligibility criteria of OBTAIN A CONSUMER'S FINANCIAL DATA OPERATION 205 includes consumer's who have made purchases from one or more identified product and/or service providers. In this example, a given consumer's financial transaction data indicating payee identification of OBTAIN A CONSUMER'S FINANCIAL DATA OPERATION 205 is used to determine the eligibility of the given consumer to receive the associated coupon and/or offer.

In another example, the coupon provider defined eligibility criteria of OBTAIN A CONSUMER'S FINANCIAL DATA OPERATION 205 includes consumers who spend a defined threshold amount of money in a defined time frame in a specific category of store. In this example, a given consumer's financial transaction data indicating payee identification and payment amount of OBTAIN A CONSUMER'S FINANCIAL DATA OPERATION 205 is used to determine the eligibility of the given consumer to receive the associated coupon and/or offer.

In another example, the coupon provider defined eligibility criteria of OBTAIN A CONSUMER'S FINANCIAL DATA OPERATION 205 includes consumers who spend a defined threshold amount of money in a defined time frame on specific products and/or services. In this example, a given consumer's financial transaction data indicating payee identification, and/or level 3 receipt data, transaction data, and payment amount data of OBTAIN A CONSUMER'S FINANCIAL DATA OPERATION 205 is used to determine the eligibility of the given consumer to receive the associated coupon and/or offer.

In another example, the coupon provider defined eligibility criteria of OBTAIN A CONSUMER'S FINANCIAL DATA OPERATION 205 includes consumers who shop with the coupon provider, or other identified product and/or service providers, a threshold number of times over a defined time frame. In this example, a given consumer's financial transaction data indicating payee identification, transaction date, and payment amount data of OBTAIN A CONSUMER'S FINANCIAL DATA OPERATION 205 is used to determine the eligibility of the given consumer to receive the associated coupon and/or offer.

In another example, the coupon provider defined eligibility criteria of OBTAIN A CONSUMER'S FINANCIAL DATA OPERATION 205 includes consumers who have recently purchased specific products and/or services related to the products and/or services offered by the coupon provider. In this example, a given consumer's financial transaction data indicating payee identification, and/or level 3 receipt data, and transaction date data of OBTAIN A CONSUMER'S FINANCIAL DATA OPERATION 205 is used to determine the eligibility of the given consumer to receive the associated coupon and/or offer.

In another example, the coupon provider defined eligibility criteria of OBTAIN A CONSUMER'S FINANCIAL DATA OPERATION 205 includes consumers who have a defined income and/or discretionary spending budget. In this example, a given consumer's financial data indicating categorized spending data, income data, debt payment data, and/or other general income and expense data of OBTAIN A CONSUMER'S FINANCIAL DATA OPERATION 205 is used to determine the eligibility of the given consumer to receive the associated coupon and/or offer.

In another example, the coupon provider defined eligibility criteria of OBTAIN A CONSUMER'S FINANCIAL DATA OPERATION 205 includes consumers who meet various economic and social demographics. In this example, a given consumer's financial data indicating categorized spending data, and/or general income and expense data, and/or general user information data, and/or transaction data of OBTAIN A CONSUMER'S FINANCIAL DATA OPERATION 205 is used to determine the eligibility of the given consumer to receive the associated coupon and/or offer.

In another example, the coupon provider defined eligibility criteria of OBTAIN A CONSUMER'S FINANCIAL DATA OPERATION 205 includes consumers who shop in a defined geographic location. In this example, a given consumer's financial transaction data indicating payee location and the transaction date data of OBTAIN A CONSUMER'S FINANCIAL DATA OPERATION 205 is used to determine the eligibility of the given consumer to receive the associated coupon and/or offer.

The specific examples discussed above are but a few specific examples of the numerous possible ways of using/processing the consumer's financial data of OBTAIN A CONSUMER'S FINANCIAL DATA OPERATION 205 and the data representing the one or more coupon eligibility criterion of OBTAIN THE ONE OR MORE COUPON ELIGIBILITY CRITERION DATA FROM THE COUPON PROVIDER OPERATION 203 to identify one or more coupons that the consumer is eligible to receive.

In one embodiment once one or more coupons are identified that the consumer is eligible to receive using the consumer's financial data of OBTAIN A CONSUMER'S FINANCIAL DATA OPERATION 205 and the data representing the one or more coupon eligibility criterion of OBTAIN THE ONE OR MORE COUPON ELIGIBILITY CRITERION DATA FROM THE COUPON PROVIDER OPERATION 203 at IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207, process flow proceeds to PROVIDE THE CONSUMER ACCESS TO THE ONE OF MORE COUPONS THE CONSUMER IS ELIGIBLE TO RECEIVE OPERATION 209.

In one embodiment, at PROVIDE THE CONSUMER ACCESS TO THE ONE OF MORE COUPONS THE CONSUMER IS ELIGIBLE TO RECEIVE OPERATION 209 the consumer is provided access to the one or more coupons identified that the consumer is eligible to receive of IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207.

In one embodiment, the consumer is provided access to the one or more coupons identified that the consumer is eligible to receive at PROVIDE THE CONSUMER ACCESS TO THE ONE OF MORE COUPONS THE CONSUMER IS ELIGIBLE TO RECEIVE OPERATION 209 by storing data representing the one or more coupons identified and then providing the consumer access to the coupon data/coupons, either directly or through a computing system implemented financial management system.

In one embodiment, the consumer is provided access to the one or more coupons identified that the consumer is eligible to receive at PROVIDE THE CONSUMER ACCESS TO THE ONE OF MORE COUPONS THE CONSUMER IS ELIGIBLE TO RECEIVE OPERATION 209 by transferring data representing the one or more coupons identified that the consumer is eligible to receive to the consumer, either directly or through a computing system implemented financial management system.

For instance, in one embodiment, data representing the one or more coupons identified that the consumer is eligible to receive is stored in whole, or in part, in a database maintained by, accessible by, owned by, or otherwise related to: process for providing coupons to select consumers 200, and/or a provider of process for providing coupons to select consumers 200; a computing system implemented financial management system, and/or a provider of a computing system implemented financial management system; and/or one or more coupon providers; and/or any other party, by any one of the numerous mechanisms known to those of skill in the art. For instance, in one embodiment, the data, in whole, or in part, is stored in a memory system, such as memory systems 103 and 153 or server memory system 123, or database 170, of FIG. 1, or in a cache memory, such as cache memories 103A and 153A of FIG. 1, or in any main memory or mass memory, associated with a computing system, such as computing system 100/150 described above. In one embodiment, the data, in whole, or in part, is stored in any computing system and/or server system, such as computing system 100/150 or server system 120, or other device, in another location, or on/in a computer readable medium, and/or any other computer program product, as defined herein. In one embodiment, the data, in whole, or in part, is stored on a webpage, in a web-based system or on a public network such as the Internet.

Returning to FIG. 2, in some embodiments, the data stored as described above is maintained, in whole, or in part, by: process for providing coupons to select consumers 200, and/or a provider of process for providing coupons to select consumers 200; a computing system implemented financial management system, and/or a provider of a computing system implemented financial management system; one or more coupon providers; a third party data storage institution; any third party service or institution; or any other parties. In these embodiments, the consumer is provided access to the one or more coupons identified that the consumer is eligible to receive at PROVIDE THE CONSUMER ACCESS TO THE ONE OF MORE COUPONS THE CONSUMER IS ELIGIBLE TO RECEIVE OPERATION 209 by providing the consumer access to the data, either directly or through a computing system implemented financial management system and/or using a computer program product.

In one embodiment, data representing the one or more coupons identified that the consumer is eligible to receive is provided to consumer at PROVIDE THE CONSUMER ACCESS TO THE ONE OF MORE COUPONS THE CONSUMER IS ELIGIBLE TO RECEIVE OPERATION 209 through a network of computing systems and/or server systems that is comprised of multiple different computers, wireless devices, cellular telephones, digital telephones, two-way pagers, personal digital assistants, server computers, or any desired combination of these devices, that are interconnected using a network, such as network 130 of FIG. 1. As discussed above, network 130 can be any network or network system that is of interest to a user such as a Local Area Network (LAN), a Wide Area Network (WAN), a public network, such as the Internet, a private network, a combination of network types, or other network capable of allowing communication between two or more computing systems, whether available or known at the time of filing or as later developed.

Returning to FIG. 2, in other embodiments, data representing the one or more coupons identified that the consumer is eligible to receive is provided to consumer at PROVIDE THE CONSUMER ACCESS TO THE ONE OF MORE COUPONS THE CONSUMER IS ELIGIBLE TO RECEIVE OPERATION 209 through e-mail or through text messaging. In one embodiment, data representing the one or more coupons identified that the consumer is eligible to receive is provided to consumer at PROVIDE THE CONSUMER ACCESS TO THE ONE OF MORE COUPONS THE CONSUMER IS ELIGIBLE TO RECEIVE OPERATION 209 by through any method, apparatus, process or mechanism for transferring data, images, screen displays, and/or text from one or more devices, computing systems, server systems, databases, web site/web functions and/or any devices having a data storage capability to one or more other devices, computing systems, server systems, databases, web site/web functions and/or any devices having a data storage and/or display capability, whether known at the time of filing or as thereafter developed.

In other embodiments, data representing the one or more coupons identified that the consumer is eligible to receive is provided to consumer at PROVIDE THE CONSUMER ACCESS TO THE ONE OF MORE COUPONS THE CONSUMER IS ELIGIBLE TO RECEIVE OPERATION 209 using traditional printed coupons and/or traditional mail services.

In one embodiment, once the consumer is provided access to the one or more coupons identified that the consumer is eligible to receive at PROVIDE THE CONSUMER ACCESS TO THE ONE OF MORE COUPONS THE CONSUMER IS ELIGIBLE TO RECEIVE OPERATION 209, process flow proceeds to EXIT OPERATION 230. In one embodiment, at EXIT OPERATION 230, process for providing coupons to select consumers 200 is exited to await new data.

Using process for providing coupons to select consumers 200, a coupon provider is given the ability to distribute coupons to select consumers who meet the coupon eligibility criteria defined by the coupon provider. Then, using process for providing coupons to select consumers 200, consumers meeting the coupon eligibility criteria are identified using financial data from various sources as obtained using a computing system implemented financial management system. Therefore, using process for providing coupons to select consumers 200, consumers meeting the coupon eligibility criteria are identified based on more complete financial data than is typically currently available through any one source of financial data.

Consequently, using process for providing coupons to select consumers 200, the coupon providers are able to target select consumers based on more complete and accurate information. As a result, not only are the coupon providers given the ability to identify and target particularly desirable consumers for coupon distribution, but the desirable consumers are also provided savings that would be otherwise perhaps not be provided to them.

In one embodiment, the consumer is provided access to the one or more coupons identified that the consumer is eligible to receive by transferring the data to, and/or providing access to the data, representing the one or more coupons to the consumer through a computing system implemented financial management system and within the context of one or more financial transactions considered relevant to the one or more coupons by the coupon provider and/or the provider of the process for providing coupons to select consumers.

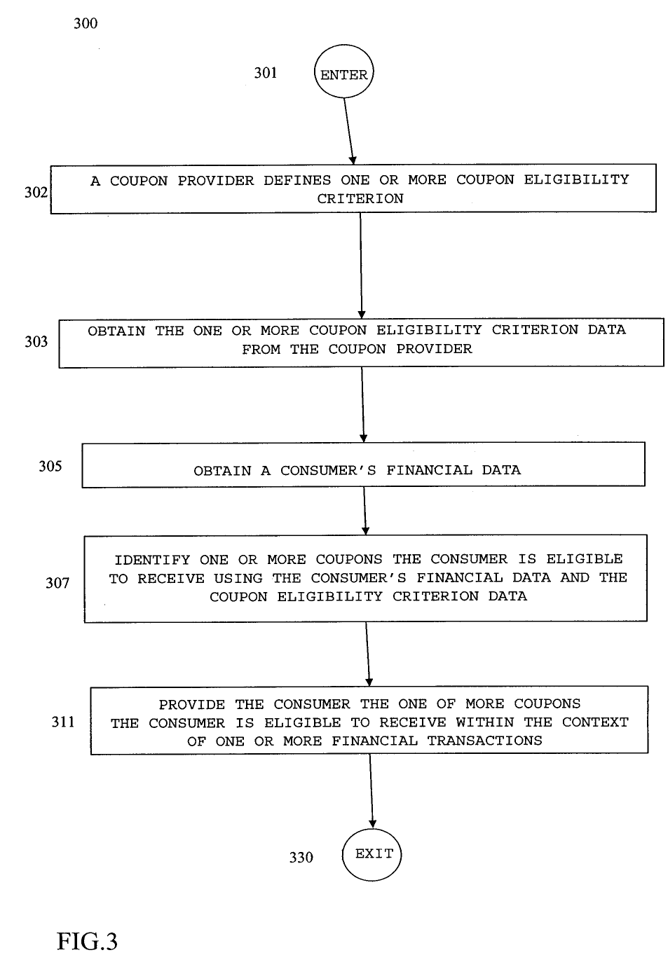

FIG. 3 a flow chart depicting a process for providing coupons to select consumers 300 in accordance with one embodiment. Process for providing coupons to select consumers 300 begins at ENTER OPERATION 301 of FIG. 3 and process flow proceeds to A COUPON PROVIDER DEFINES ONE OR MORE COUPON ELIGIBILITY CRITERION OPERATION 302.

In one embodiment: A COUPON PROVIDER DEFINES ONE OR MORE COUPON ELIGIBILITY CRITERION OPERATION 302; OBTAIN THE ONE OR MORE COUPON ELIGIBILITY CRITERION DATA FROM THE COUPON PROVIDER OPERATION 303; OBTAIN A CONSUMER'S FINANCIAL DATA OPERATION 305; and IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 307, of process for providing coupons to select consumers 300 and FIG. 3 are substantially identical to similarly identified and numbered operations: A COUPON PROVIDER DEFINES ONE OR MORE COUPON ELIGIBILITY CRITERION OPERATION 202; OBTAIN THE ONE OR MORE COUPON ELIGIBILITY CRITERION DATA FROM THE COUPON PROVIDER OPERATION 203; OBTAIN A CONSUMER'S FINANCIAL DATA OPERATION 205; and IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207, of process for providing coupons to select consumers 200 and FIG. 2.

Consequently, the discussion above with respect to: A COUPON PROVIDER DEFINES ONE OR MORE COUPON ELIGIBILITY CRITERION OPERATION 202; OBTAIN THE ONE OR MORE COUPON ELIGIBILITY CRITERION DATA FROM THE COUPON PROVIDER OPERATION 203; OBTAIN A CONSUMER'S FINANCIAL DATA OPERATION 205; and IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 207, of process for providing coupons to select consumers 200 and FIG. 2 is applicable to, and incorporated here for: A COUPON PROVIDER DEFINES ONE OR MORE COUPON ELIGIBILITY CRITERION OPERATION 302; OBTAIN THE ONE OR MORE COUPON ELIGIBILITY CRITERION DATA FROM THE COUPON PROVIDER OPERATION 303; OBTAIN A CONSUMER'S FINANCIAL DATA OPERATION 305; and IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 307, of process for providing coupons to select consumers 300 and FIG. 3.

In one embodiment once one or more coupons are identified that the consumer is eligible to receive using the consumer's financial data of OBTAIN A CONSUMER'S FINANCIAL DATA OPERATION 305 and the data representing the one or more coupon eligibility criterion of OBTAIN THE ONE OR MORE COUPON ELIGIBILITY CRITERION DATA FROM THE COUPON PROVIDER OPERATION 303 at IDENTIFY ONE OR MORE COUPONS THE CONSUMER IS ELIGIBLE TO RECEIVE USING THE CONSUMER'S FINANCIAL DATA AND THE COUPON ELIGIBILITY CRITERION DATA OPERATION 307, process flow proceeds to PROVIDE THE CONSUMER THE ONE OF MORE COUPONS THE CONSUMER IS ELIGIBLE TO RECEIVE WITHIN THE CONTEXT OF ONE OR MORE FINANCIAL TRANSACTIONS OPERATION 311.

In one embodiment, at PROVIDE THE CONSUMER THE ONE OF MORE COUPONS THE CONSUMER IS ELIGIBLE TO RECEIVE WITHIN THE CONTEXT OF ONE OR MORE FINANCIAL TRANSACTIONS OPERATION 311 the consumer is provided access to the one or more coupons identified that the consumer is eligible to receive by transferring the data to, and/or providing access to the data, representing the one or more coupons to the consumer through a computing system implemented financial management system, and within the context of one or more financial transactions considered relevant to the one or more coupons.

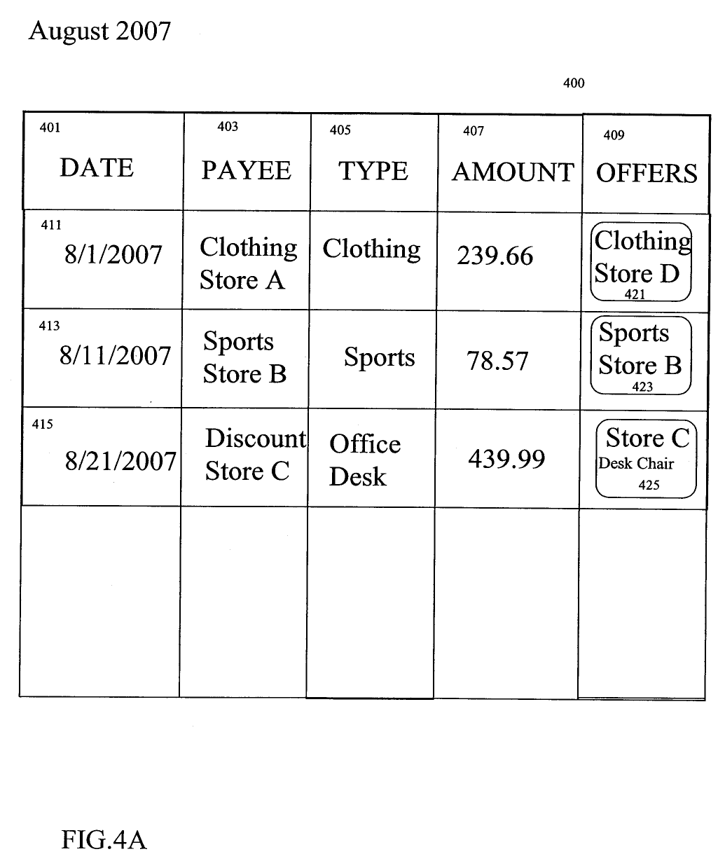

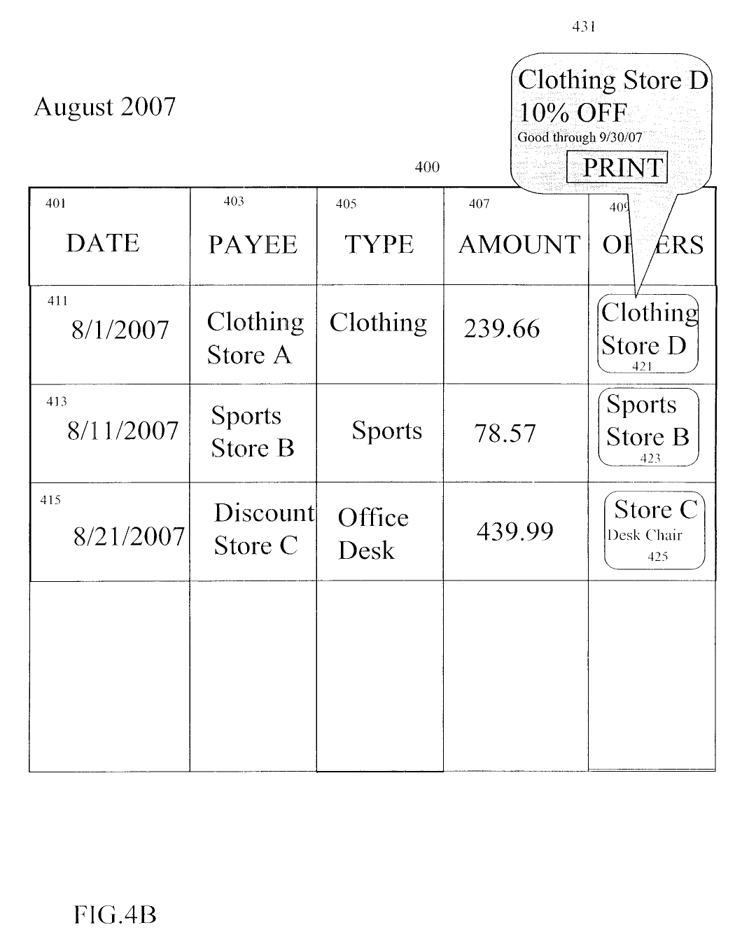

FIGS. 4A and 4B show one embodiment of a display screen generated by a computing system implemented financial management system, such as computing system implemented financial management system 180 of FIG. 1, as would be displayed on a display device, such as display devices 115, 155, or 125 of FIG. 1, in accordance with a specific example of one embodiment at PROVIDE THE CONSUMER THE ONE OF MORE COUPONS THE CONSUMER IS ELIGIBLE TO RECEIVE WITHIN THE CONTEXT OF ONE OR MORE FINANCIAL TRANSACTIONS OPERATION 311 (FIG. 3).

Shown in FIG. 4A is a display of a portion of an transaction ledger 400 as might be displayed at PROVIDE THE CONSUMER THE ONE OF MORE COUPONS THE CONSUMER IS ELIGIBLE TO RECEIVE WITHIN THE CONTEXT OF ONE OR MORE FINANCIAL TRANSACTIONS OPERATION 311 (FIG. 3). Transaction ledger 400 includes: date column 401, for displaying the date of a given transaction; payee column 403, for displaying the payee of a given transaction; type column 405, for displaying the type of payee and/or category of a given transaction; amount column 407, for displaying the transaction amount; and, in accordance with one embodiment, offer column 409 for displaying coupon offers and/or other marketing offers associated with a given transaction. Also shown in transaction ledger 400 are three transactions 411, 413, and 415.

As noted above, in one embodiment, at PROVIDE THE CONSUMER THE ONE OF MORE COUPONS THE CONSUMER IS ELIGIBLE TO RECEIVE WITHIN THE CONTEXT OF ONE OR MORE FINANCIAL TRANSACTIONS OPERATION 311 (FIG. 3) the consumer is provided access to the one or more coupons identified that the consumer is eligible to receive by transferring the data to, and/or providing access to the data, representing the one or more coupons to the consumer through a computing system implemented financial management system and within the context of one or more financial transactions, such as transactions 411, 413 and 415 of FIGS. 4A and 4B, considered relevant to the one or more coupons by the coupon provider and/or the provider of the process for providing coupons to select consumers. Consequently, in FIG. 4A: transaction 411, involving a clothing store A, has a coupon offer 421 from clothing store D, a competitor of clothing store A, in offer column 409; transaction 413, involving a sports store B, has a coupon offer 423 from sports store B representing a loyalty discount coupon offer; and transaction 415, involving a discount store C, includes a coupon offer 425 from discount store C representing a coupon for an product (a desk chair) related to the product (a desk) purchased at transaction 415.

As seen in FIG. 4B, in one embodiment, when a consumer selects one of the coupon offers 421, 423, or 425, the consumer is provided a coupon display 431 that describes the coupon in detail and, in one embodiment, provides the consumer a print coupon capability.

Those of skill in the art will readily recognize that the choice of information displayed, the organization of the information displayed, and the manner in which the information is displayed in FIG. 4A and FIG. 4B was made for illustrative purposes only and that other types of information, organization of that information, and manner of displaying the information, can be implemented without departing from the scope of the invention as set forth in the claims below. In addition, those of skill in the art will readily recognize that various means for interfacing with, activating, or editing, the information displayed in FIG. 4A and FIG. 4B are possible, and that the specific means discussed above do not limit the invention as set forth in the claims below.

In one embodiment, once the consumer is provided access to the one or more coupons identified that the consumer is eligible to receive by transferring the data to, and/or providing access to the data, representing the one or more coupons to the consumer through a computing system implemented financial management system, and within the context of one or more financial transactions considered relevant to the one or more coupons, at PROVIDE THE CONSUMER THE ONE OF MORE COUPONS THE CONSUMER IS ELIGIBLE TO RECEIVE WITHIN THE CONTEXT OF ONE OR MORE FINANCIAL TRANSACTIONS OPERATION 311, process flow proceeds to EXIT OPERATION 330. In one embodiment, at EXIT OPERATION 330 process for providing coupons to select consumers 300 is exited to await new data.

Using process for providing coupons to select consumers 300, a coupon provider is given the ability to distribute coupons to select consumers who meet the coupon eligibility criteria defined by the coupon provider. Then, using process for providing coupons to select consumers 300, consumers meeting the coupon eligibility criteria are identified using financial data from various sources as obtained using a computing system implemented financial management system. Therefore, using process for providing coupons to select consumers 300, consumers meeting the coupon eligibility criteria are identified based on more complete financial data than is typically currently available through any one source of financial data.

In addition, using process for providing coupons to select consumers 300, the consumer is provided access to one or coupons he or she is eligible for through a computing system implemented financial management system, and within the context of relevant financial transaction data.

Consequently, using process for providing coupons to select consumers 300, the coupon providers are able to target select consumers based on more complete and accurate information and provide those consumers selected one or more coupons within a relevant context.

As discussed in more detail above, using the above embodiments, with little or no modification and/or user input, there is considerable flexibility, adaptability, and opportunity for customization to meet the specific needs of various users under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “defining”, “accessing”, “analyzing”, “obtaining”, “deriving”, “determining”, “collecting”, “creating”, “identifying”, “transferring”, “storing”, “comparing”, “providing”, etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented process for providing coupons to select consumers comprising:
defining one or more coupon eligibility criterion that a consumer must meet in order to be eligible to receive a coupon;
obtaining data representing the one or more coupon eligibility criterion;
obtaining a consumer's financial data using a computing system implemented financial management system, the consumer's financial data being associated with the consumer;
analyzing the consumer's financial data and the data representing the one or more coupon eligibility criterion to identify one or more coupons the consumer is eligible to receive; and
providing the consumer access to the one or more coupons the consumer is eligible to receive.

2. The computing system implemented process for providing coupons to select consumers of claim 1, wherein;
the one or more coupon eligibility criterion that a consumer must meet in order to be eligible to receive a coupon comprises one or more eligibility criterion from the following list of eligibility criterion:
consumers who have made purchases from one or more identified product and/or service providers;
consumers who spend a defined threshold amount of money in a defined category of store;
consumers who spend a defined threshold amount of money on defined products and/or services;
consumers who shop with a coupon provider a threshold number of times;
consumers who have purchased defined products and/or services related to the products and/or services offered by a coupon provider;
consumers who shop in a defined geographic location;
consumers who have a defined income and/or discretionary spending budget; or
consumers who meet defined demographics.

3. The computing system implemented process for providing coupons to select consumers of claim 1, wherein;
the computing system implemented financial management system is a computing system implemented personal financial management system.

4. The computing system implemented process for providing coupons to select consumers of claim 1, wherein;
obtaining a consumer's financial data using a computing system implemented financial management system comprises obtaining at least part of the consumer's financial data from one or more of the following sources:
a bank;
a debit card account;
a credit union; or
a credit card account.

5. The computing system implemented process for providing coupons to select consumers of claim 1, wherein;
obtaining a consumer's financial data using a computing system implemented financial management system comprises obtaining at least part of the consumer's financial data from two or more of the following sources:
a bank;
a debit card account;
a credit union; or
a credit card account.

6. The computing system implemented process for providing coupons to select consumers of claim 1, wherein;
obtaining a consumer's financial data using a computing system implemented financial management system comprises obtaining a consumer's financial transaction data.

7. The computing system implemented process for providing coupons to select consumers of claim 6, wherein;
the consumer's financial transaction data represents two or more payments made by the consumer to one or more consumer payees from two or more payment sources.

8. The computing system implemented process for providing coupons to select consumers of claim 1, wherein;
providing the consumer access to the one or more coupons the consumer is eligible to receive comprises storing data representing the one or more coupons the consumer is eligible to receive and providing the consumer access to the data representing the one or more coupons the consumer is eligible to receive.

9. The computing system implemented process for providing coupons to select consumers of claim 1, wherein;
providing the consumer access to the one or more coupons the consumer is eligible to receive comprises transferring data representing the one or more coupons the consumer is eligible to receive to a computing system accessible by the consumer.

10. The computing system implemented process for providing coupons to select consumers of claim 9, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions.

11. The computing system implemented process for providing coupons to select consumers of claim 9, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions that are part of a listing of transactions generated by the computing system implemented financial management system.

12. A computer program product for providing a process for providing coupons to select consumers comprising:
a computer readable medium;
and computer program code, encoded on the computer readable medium, comprising computer readable instructions for:
obtaining data representing one or more coupon eligibility criterion that a consumer must meet in order to be eligible to receive a coupon;
obtaining a consumer's financial data using a computing system implemented financial management system, the consumer's financial data being associated with the consumer;
analyzing the consumer's financial data and the data representing the one or more coupon eligibility criterion to identify one or more coupons the consumer is eligible to receive; and
providing the consumer access to the one or more coupons the consumer is eligible to receive.

13. The computer program product for providing a process for providing coupons to select consumers of claim 12, wherein;
the one or more coupon eligibility criterion that a consumer must meet in order to be eligible to receive a coupon comprises one or more eligibility criterion from the following list of eligibility criterion:
consumers who have made purchases from one or more identified product and/or service providers;
consumers who spend a defined threshold amount of money in a defined category of store;
consumers who spend a defined threshold amount of money on defined products and/or services;
consumers who shop with a coupon provider a threshold number of times;
consumers who have purchased defined products and/or services related to the products and/or services offered by a coupon provider;
consumers who shop in a defined geographic location;
consumers who have a defined income and/or discretionary spending budget; or
consumers who meet defined demographics.

14. The computer program product for providing a process for providing coupons to select consumers of claim 12, wherein;
the computing system implemented financial management system is a computing system implemented personal financial management system.

15. The computer program product for providing a process for providing coupons to select consumers of claim 12, wherein;
obtaining a consumer's financial data using a computing system implemented financial management system comprises obtaining at least part of the consumer's financial data from one or more of the following sources:
a bank;
a debit card account;
a credit union; or
a credit card account.

16. The computer program product for providing a process for providing coupons to select consumers of claim 12, wherein;
obtaining a consumer's financial data using a computing system implemented financial management system comprises obtaining at least part of the consumer's financial data from two or more of the following sources:
a bank;
a debit card account;
a credit union; or
a credit card account.

17. The computer program product for providing a process for providing coupons to select consumers of claim 12, wherein;
obtaining a consumer's financial data using a computing system implemented financial management system comprises obtaining a consumer's financial transaction data.

18. The computer program product for providing a process for providing coupons to select consumers of claim 17, wherein;
the consumer's financial transaction data represents two or more payments made by the consumer to one or more consumer payees from two or more payment sources.

19. The computer program product for providing a process for providing coupons to select consumers of claim 12, wherein;
providing the consumer access to the one or more coupons the consumer is eligible to receive comprises storing data representing the one or more coupons the consumer is eligible to receive and providing the consumer access to the data representing the one or more coupons the consumer is eligible to receive.

20. The computer program product for providing a process for providing coupons to select consumers of claim 12, wherein;
providing the consumer access to the one or more coupons the consumer is eligible to receive comprises transferring data representing the one or more coupons the consumer is eligible to receive to a computing system accessible by the consumer.

21. The computer program product for providing a process for providing coupons to select consumers of claim 20, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions.

22. The computer program product for providing a process for providing coupons to select consumers of claim 20, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions that are part of a listing of transactions generated by the computing system implemented financial management system.

23. A system for providing coupons to select consumers comprising:
a computing system implemented financial management system; and
a processor for executing at least part of a process for providing coupons to select consumers, the process for providing coupons to select consumers comprising:
obtaining data representing one or more coupon eligibility criterion that a consumer must meet in order to be eligible to receive a coupon;
obtaining a consumer's financial data using the computing system implemented financial management system, the consumer's financial data being associated with the consumer;
analyzing the consumer's financial data and the data representing the one or more coupon eligibility criterion to identify one or more coupons the consumer is eligible to receive; and
providing the consumer access to the one or more coupons the consumer is eligible to receive.

24. The system for providing coupons to select consumers of claim 23, wherein;
the one or more coupon eligibility criterion that a consumer must meet in order to be eligible to receive a coupon comprises one or more eligibility criterion from the following list of eligibility criterion:
consumers who have made purchases from one or more identified product and/or service providers;
consumers who spend a defined threshold amount of money in a defined category of store;
consumers who spend a defined threshold amount of money on defined products and/or services;
consumers who shop with a coupon provider a threshold number of times;
consumers who have purchased defined products and/or services related to the products and/or services offered by a coupon provider;
consumers who shop in a defined geographic location;
consumers who have a defined income and/or discretionary spending budget; or
consumers who meet defined demographics.

25. The system for providing coupons to select consumers of claim 23, wherein;
the computing system implemented financial management system is a computing system implemented personal financial management system.

26. The system for providing coupons to select consumers of claim 23, wherein;
obtaining a consumer's financial data using a computing system implemented financial management system comprises obtaining at least part of the consumer's financial data from one or more of the following sources:
a bank;
a debit card account;
a credit union; or
a credit card account.

27. The system for providing coupons to select consumers of claim 23, wherein;
obtaining a consumer's financial data using a computing system implemented financial management system comprises obtaining at least part of the consumer's financial data from two or more of the following sources:
a bank;
a debit card account;
a credit union; or
a credit card account.

28. The system for providing coupons to select consumers of claim 23, wherein;
obtaining a consumer's financial data using a computing system implemented financial management system comprises obtaining a consumer's financial transaction data.

29. The system for providing coupons to select consumers of claim 28, wherein;
the consumer's financial transaction data represents two or more payments made by the consumer to one or more consumer payees from two or more payment sources.

30. The system for providing coupons to select consumers of claim 23, wherein;
providing the consumer access to the one or more coupons the consumer is eligible to receive comprises storing data representing the one or more coupons the consumer is eligible to receive and providing the consumer access to the data representing the one or more coupons the consumer is eligible to receive.

31. The system for providing coupons to select consumers of claim 23, wherein;
providing the consumer access to the one or more coupons the consumer is eligible to receive comprises transferring data representing the one or more coupons the consumer is eligible to receive to a computing system accessible by the consumer.

32. The system for providing coupons to select consumers of claim 31, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions.

33. The system for providing coupons to select consumers of claim 31, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions that are part of a listing of transactions generated by the computing system implemented financial management system.

34. A method for providing coupons to select consumers comprising:
defining one or more coupon eligibility criterion that a consumer must meet in order to be eligible to receive a coupon;
obtaining data representing the one or more coupon eligibility criterion;
obtaining a consumer's financial data using a computing system implemented financial management system, the consumer's financial data being associated with the consumer;
analyzing the consumer's financial data and the data representing the one or more coupon eligibility criterion to identify one or more coupons the consumer is eligible to receive; and
providing the consumer access to the one or more coupons the consumer is eligible to receive.

35. The method for providing coupons to select consumers of claim 34, wherein;
the one or more coupon eligibility criterion that a consumer must meet in order to be eligible to receive a coupon comprises one or more eligibility criterion from the following list of eligibility criterion:
consumers who have made purchases from one or more identified product and/or service providers;
consumers who spend a defined threshold amount of money in a defined category of store;
consumers who spend a defined threshold amount of money on defined products and/or services;
consumers who shop with a coupon provider a threshold number of times;
consumers who have purchased defined products and/or services related to the products and/or services offered by a coupon provider;
consumers who shop in a defined geographic location;
consumers who have a defined income and/or discretionary spending budget; or
consumers who meet defined demographics.

36. The method for providing coupons to select consumers of claim 34, wherein;
the computing system implemented financial management system is a computing system implemented personal financial management system.

37. The method for providing coupons to select consumers of claim 34, wherein;
obtaining a consumer's financial data using a computing system implemented financial management system comprises obtaining at least part of the consumer's financial data from one or more of the following sources:
a bank;
a debit card account;
a credit union; or
a credit card account.

38. The method for providing coupons to select consumers of claim 34, wherein;
obtaining a consumer's financial data using a computing system implemented financial management system comprises obtaining at least part of the consumer's financial data from two or more of the following sources:
a bank;
a debit card account;
a credit union; or
a credit card account.

39. The method for providing coupons to select consumers of claim 34, wherein;
obtaining a consumer's financial data using a computing system implemented financial management system comprises obtaining a consumer's financial transaction data.

40. The method for providing coupons to select consumers of claim 39, wherein;
the consumer's financial transaction data represents two or more payments made by the consumer to one or more consumer payees from two or more payment sources.

41. The method for providing coupons to select consumers of claim 34, wherein;
providing the consumer access to the one or more coupons the consumer is eligible to receive comprises storing data representing the one or more coupons the consumer is eligible to receive and providing the consumer access to the data representing the one or more coupons the consumer is eligible to receive.

42. The method for providing coupons to select consumers of claim 34, wherein;
providing the consumer access to the one or more coupons the consumer is eligible to receive comprises transferring data representing the one or more coupons the consumer is eligible to receive to a computing system accessible by the consumer.

43. The method for providing coupons to select consumers of claim 42, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions.

44. The method for providing coupons to select consumers of claim 42, wherein;
providing the consumer access to the one or more coupons the consumer is eligible to receive comprises transferring data representing the one or more coupons the consumer is eligible to receive to a computing system accessible by the consumer and displaying the one or more coupons on the computing system accessible by the consumer within the context of one or more financial transactions that are part of a listing of transactions generated by the computing system implemented financial management system.
